(19) United States
(12) Patent Application Publication
(10) Pub. No.: US 2009/0040351 A1
(43) Pub. Date: Feb. 12, 2009

(54) Method and apparatus for reducing noise in a pixel array

(75) Inventor: Taehee Cho, Irvine, CA (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 11/889,171

(22) Filed: Aug. 9, 2007

(51) Int. Cl. H04N 5/335

(52) U.S. Cl. 348/308; 348/E05.091

(57) ABSTRACT

A method and apparatus for sampling pixels from a pixel array, the pixels being sampled at different times.

### FIELD OF THE INVENTION

The embodiments disclosed herein relate generally to semiconductor imagers and, more specifically, to noise reduction in semiconductor imagers.

### BACKGROUND OF THE INVENTION

Various types of imagers or image sensors are currently used, including charge-coupled device (“CCD”) image sensors and complementary metal-oxide semiconductor (“CMOS”) image sensors. CMOS technology offers many benefits, such as lower cost, ease of manufacturing, and a higher degree of integration over CCD image sensors. However, CMOS image sensors may suffer from the presence of fixed-pattern noise (“FPN”) and temporal noise. Fixed pattern noise is generated from a mismatch of circuit structures due to variations in the manufacturing processes of integrated circuits. The effect of fixed pattern noise in a CMOS image sensor is that groups of pixel cells, typically different columns in a sensor array, exhibit relatively different signal strengths in response to uniform input light. Temporal noise is random noise and may affect individual pixels, or, as explained below, rows of pixels.

FIG. 1 demonstrates the effect of fixed pattern noise and temporal noise on an image. In FIG. 1, an image 10 is sensed by the CMOS image sensor 20 via a sensor array 30. The sensor array 30 includes a matrix of pixel cells 32. Because of noise in the sensor array 30, a noise-corrupted image 40 is generated by the CMOS image sensor 20. Fixed pattern noise is largely responsible for the column-wise distortion which appears in the noise-corrupted image 40. Temporal noise is generally responsible for the row-wise and otherwise random distortion which appears in the noise-corrupted image 40. Although many solutions exist for correcting fixed pattern column noise, effective solutions for correcting temporal row noise are still desired.

One source of temporal row-wise noise relates to a common method used for reading-out signals from a pixel array, as explained in relation to FIGS. 2-5. FIG. 2 illustrates a block-diagram of a semiconductor CMOS imager 100 having a pixel array 140 including a plurality of pixel cells arranged in a predetermined number of columns and rows. Each pixel cell is configured to receive incident photons and to convert the incident photons into electrical signals. Pixel cells of pixel array 140 are output row-by-row as activated by a row driver 145 in response to a row address decoder 155. Column driver 160 and column address decoder 170 are also used to selectively activate individual pixel columns. A timing and control circuit 150 controls address decoders 155, 170 for selecting the appropriate row and column lines for pixel readout. The control circuit 150 also controls the row and column driver circuitry 145, 160 such that driving voltages may be applied. The signals controlled by the control circuit 150 include the signals depicted in the timing diagrams of FIGS. 4-5B, as explained below. Each pixel cell generally outputs both a pixel reset signal vᵣₛₜ and a pixel image signal v_{sig}, which are read by a sample and hold circuit 161 according to a correlated double sampling (“CDS”) scheme. The pixel reset signal vᵣₛₜ represents a reset state of a pixel cell. The pixel image signal v_{sig} represents the amount of charge generated by the photosensor in the pixel cell in response to applied light during an integration period. The pixel reset and image signals vᵣₛₜ, v_{sig} are sampled, held and amplified by the sample and hold circuit 161. The sample and hold circuit 161 outputs amplified pixel reset and image signals Vᵣₛₜ, V_{sig}. The difference between V_{sig} and Vᵣₛₜ represents the actual pixel cell output with common-mode noise eliminated. The differential signal (Vᵣₛₜ−V_{sig}) is produced by differential amplifier 162 for each readout pixel cell. The differential signals are digitized by an analog-to-digital converter 175. The analog-to-digital converter 175 supplies the digitized pixel signals to an image processor 180, which forms and outputs a digital image.

The sample and hold circuit 161 is illustrated in more detail in FIG. 3. In FIG. 3, the sample and hold circuit 161 is used to sample and hold both the reset signal vᵣₛₜ and the image signal v_{sig} for each pixel in a row (e.g., R1, R2, R3). In other words, the sample and hold circuit 161 includes circuitry to sample and simultaneously hold two signals for each pixel column (e.g., C1, C2, C3, Cn). The sample and hold circuit 161 may also include an amplifier 110 for amplifying the sampled and held signals before they are passed to the differential amplifier 162 (FIG. 2).

In the pixel array 140, each pixel in a row R1, R2, R3 is sampled at the same time. Pixels in row R1 are each sampled simultaneously so that each pixel's reset signal vᵣₛₜ and image signal v_{sig} are sampled and held concurrently by each column's sample and hold circuitry. A pixel's reset signal vᵣₛₜ is stored in a capacitor C connected to the switch controlled by the reset sample and hold control signal shr. A pixel's image signal v_{sig} is stored in a capacitor C connected to the switch controlled by the signal sample and hold control signal shs. For example, and as indicated in the timing diagram of FIG. 4, all columns C1-Cn sample a pixel reset signal vᵣₛₜ when the reset sample and hold control signal shr is high. Thus, column C1 obtains a reset signal vᵣₛₜ for a pixel in row R1 at the same time that columns C2-Cn obtain reset signals vᵣₛₜ for pixels in row R1. Similarly, all columns C1-Cn sample an image signal v_{sig} when the signal sample and hold control signal shs is high. Column C1 obtains an image signal v_{sig} for a pixel in row R1 at the same time that columns C2-Cn obtain image signals v_{sig} for pixels in row R1. The sampling period occurs while the output side of capacitors C are clamped at V_{ref} (while control signal c1 is high). Once the control signal c1 becomes low and the output sides of the capacitors C are no longer biased at V_{ref}, the capacitors C are allowed to discharge through amplifier 110 according to a timing scheme illustrated in FIG. 4. The amplifier 110 periodically outputs signals Vᵣₛₜ, V_{sig} for the sampled pixel in each column when amplifier control signal Φₐₘₚ and the column's column select signal c1-cn is high. Thus, the signals Vᵣₛₜ, V_{sig} from a pixel in column C1 are output when both the amplifier control signal Φₐₘₚ and the column select signal c1 are high. Subsequently, the signals Vᵣₛₜ, V_{sig} from a pixel in column C2 are output when both the amplifier control signal Φₐₘₚ and the column select signal c2 are high. Once all signals Vᵣₛₜ, V_{sig} from pixels in row R1 are output, the process begins anew by sampling and holding signals from pixels in row R2, and so forth.

As described above, the signals vᵣₛₜ for the pixels in a pixel row are obtained simultaneously, as are the v_{sig} signals. All reset signals vᵣₛₜ for pixels in row R1 are sampled at the same time, at the falling edge of control signal shr. Additionally, all image signals v_{sig} for pixels in row R1 are sampled at the same time, at the falling edge of control signal shs. The simultaneous sampling of all reset or image signals vᵣₛₜ, v_{sig} in a row can result in row-wise temporal noise as illustrated in FIG. 1. A noise that is present at the time that the reset signals vᵣₛₜ are sampled (at the falling edge of control signal shr) will appear in all simultaneously sampled reset signals vᵣₛₜ. Similarly, a noise that is present at the time that the image signals v_{sig} are sampled (at the falling edge of control signal shs) will appear in all simultaneously sampled image signals v_{sig}. Because simultaneously sampled reset or image signals vᵣₛₜ, v_{sig} are from pixels in a common row, temporal row-wise noise will appear in an image resulting from the sampling. FIGS. 5A and 5B are timing diagrams that illustrate the effect of noise when pixels signals vᵣₛₜ, v_{sig} are each sampled simultaneously for all pixels in a row.

A case wherein no temporal noise is detected is presented in FIG. 5A. In FIG. 5A, a reset signal vᵣₛₜ and an image signal v_{sig} are sampled for a row when control signals shr, shs are made high. In this case, for ease of explanation, the reset signal vᵣₛₜ and the image signal v_{sig} are identical—i.e., there is no image being acquired. Hence, the pixel out signal is constant. In this specific example, no additional temporal noise is detected either—the noise signal is also constant. Thus, when differential amplifier 162 (FIG. 2) determines the difference between the Vᵣₛₜ and V_{sig} pixel output signals, the resulting output for each column is the true value of the sampled pixel, as illustrated in FIG. 5A.

FIG. 5B illustrates what happens when a noise spike is detected in the reset signal vᵣₛₜ sampled at the falling edge of the shr signal. When noise levels in the reset and image signals vᵣₛₜ, v_{sig} are the same (referring to noise levels present at the times of the falling edges of the shr and shs signals), the differential output of the acquired reset and image signals is the pixel output level, as illustrated in FIG. 5A. However, when the noise levels in the reset and image signals vᵣₛₜ, v_{sig} are different (referring to noise levels present at the times of the falling edges of the shr and shs signals), as in this case, the noise affects the column outputs. In FIG. 5B, the 1 V noise spike detected at the falling edge of the shr signal, creating a difference between the vᵣₛₜ signal and the v_{sig} signal, results in a 1 V offset for the differential pixel signals. Because all pixels in a row are sampled at the same time, the noise is reflected in the vᵣₛₜ signals of each pixel in the row. Thus, the entire row is offset, resulting in the row-wise temporal noise as illustrated in FIG. 1.

There is, therefore, a need and a desire for circuits and methods that reduce the effect of row-wise temporal noise in imagers.

### BRIEF DESCRIPTION OF THE DRAWINGS

FIG. 1 illustrates the effect of fixed pattern noise and temporal noise on an image.

FIG. 2 is a block diagram of a CMOS semiconductor imager.

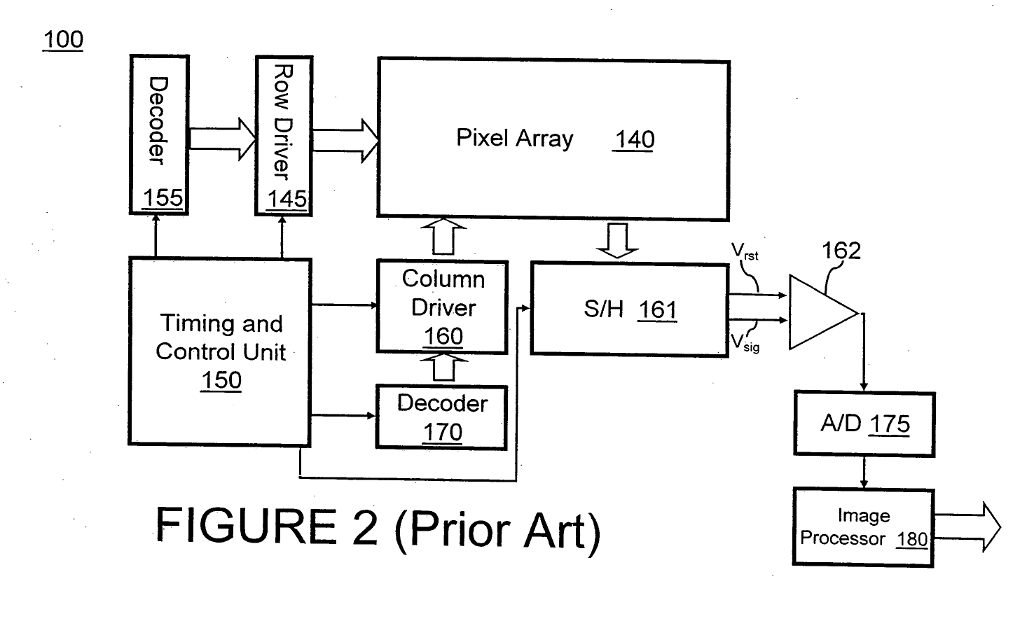

FIG. 3 is a schematic diagram of a conventional sample and hold circuit.

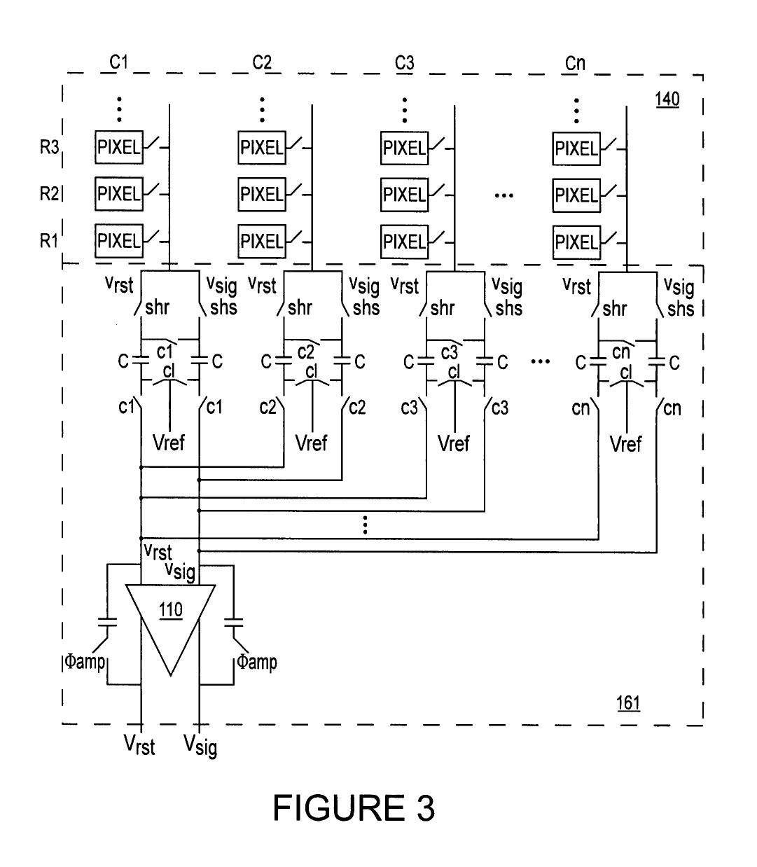

FIG. 4 is a timing diagram for a conventional sample and hold circuit.

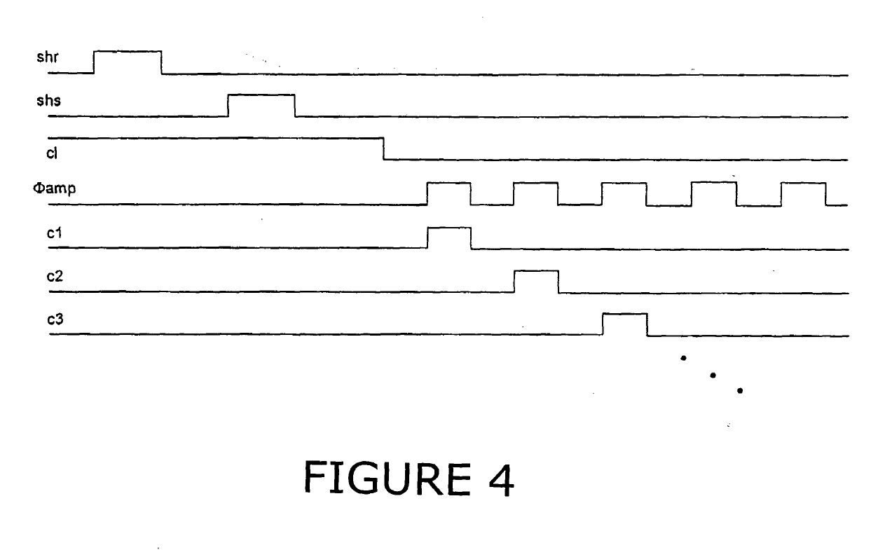

FIGS. 5A and 5B are timing diagrams for a conventional sample and hold circuit.

FIG. 6 is a schematic diagram of sample and hold circuit, according to a disclosed embodiment.

FIG. 7 is a timing diagram for a sample and hold circuit, according to a disclosed embodiment.

FIG. 8 is a timing diagram for a sample and hold circuit, according to a disclosed embodiment.

FIG. 9 is a timing diagram for a sample and hold circuit, according to a disclosed embodiment.

FIG. 10 is a block diagram of a pixel array and sample and hold circuit, according to a disclosed embodiment.

FIG. 11 is a block diagram of a processing system with an imager, according to a disclosed embodiment.

### DETAILED DESCRIPTION

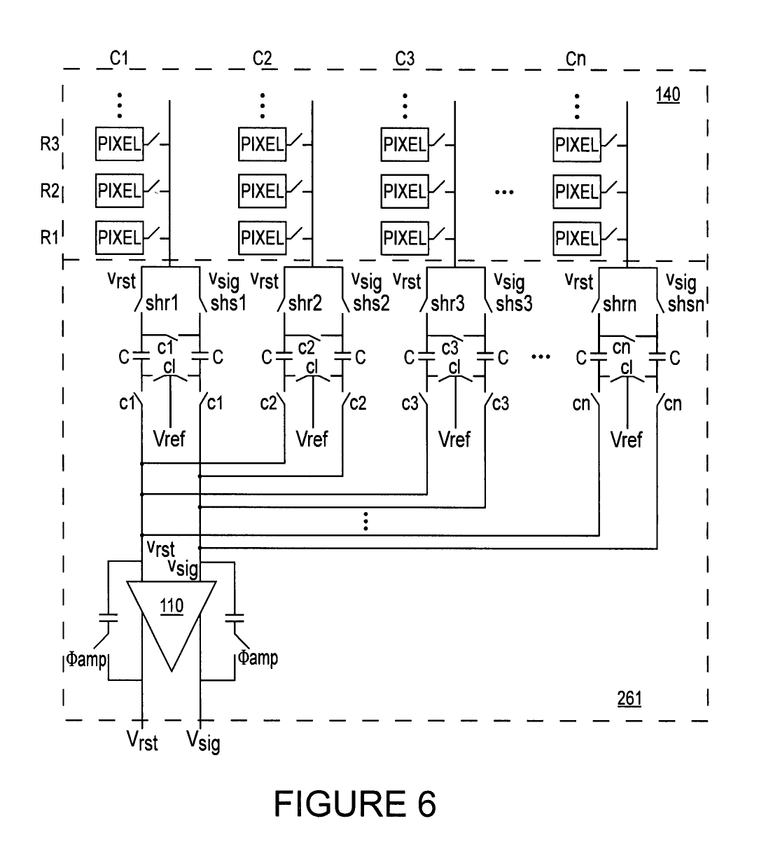

In order to reduce row-wise temporal noise in an imager, additional timing and control signals are used to stagger the sampling of individual pixel reset signals vᵣₛₜ and individual pixel image signals v_{sig} within a row. FIG. 6 illustrates a sampling and hold circuit 261 in accordance with a disclosed embodiment. In the sampling and hold circuit 261, each pixel column C1-Cn has associated circuitry to sample and hold a pixel reset signal vᵣₛₜ and a pixel image signal v_{sig}. In column C1, the sampling of a pixel reset signal vᵣₛₜ is controlled by a reset sample and hold control signal shr1. In column C2, the sampling of a pixel reset signal vᵣₛₜ is controlled by a reset sample and hold control signal shr2. Each column C1-Cn has an associated reset sample and hold control signal shr1-shrn. Similarly, each column C1-Cn has an associated image sample and hold control signal shs1-shsn. Using these additional control signals, the reset and image signals vᵣₛₜ, v_{sig} for each pixel in a row may be sampled independently and need not be sampled simultaneously, as described above.

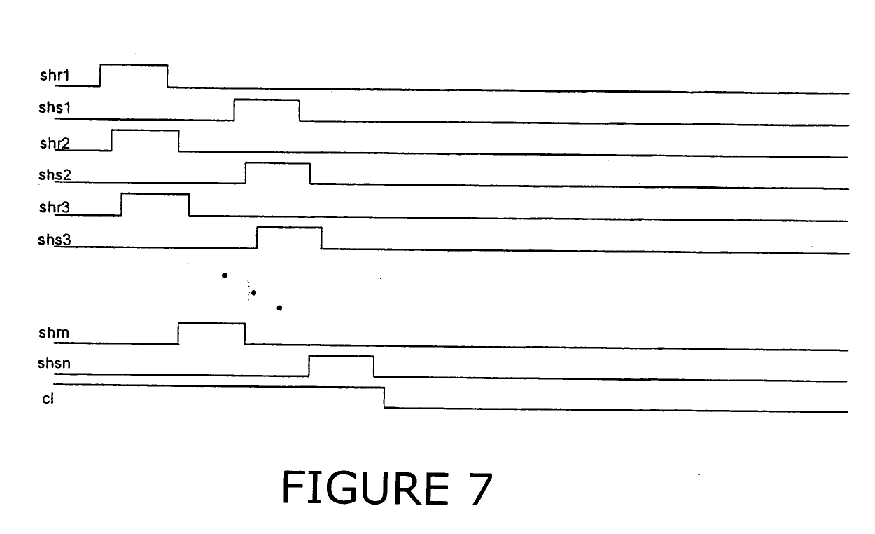

FIG. 7 illustrates an example timing diagram for the sample and hold circuit 261. As in the conventional sample and hold circuit 161, the sampling of signals vᵣₛₜ, v_{sig} for pixels in columns C1-Cn occurs while the control signal c1 is high. However, instead of using a common reset sample and hold control signal shr, resulting in the vᵣₛₜ signals in each column being sampled simultaneously, the individual reset sample and hold control signals shr1-shrn each go to a high and low level independent of each other. In the example illustrated in FIG. 7, control signal shr1 goes high and low before control signal shr2, and control signal shr2 goes high and low before control signal shr3 and so on. Control signal shrn is the last of the reset sample and hold control signals to go high and low. Similarly, the image sample and hold control signals shs1-shsn also go high and low independent of each other. In the example of FIG. 7, control signal shs1 goes high and low before control signal shs2, which goes high and low before control signal shs3 and so on. Control signal shsn is the last of the image sample and hold control signals to go high and low.

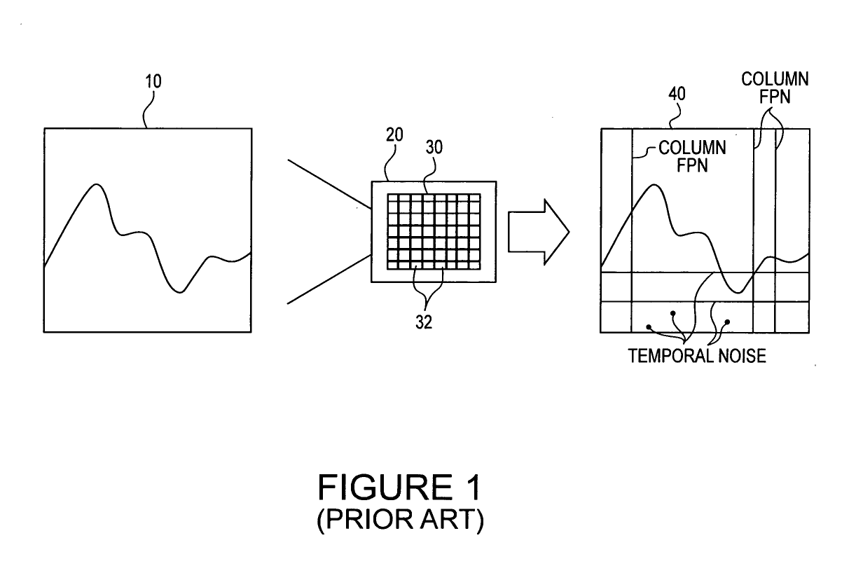

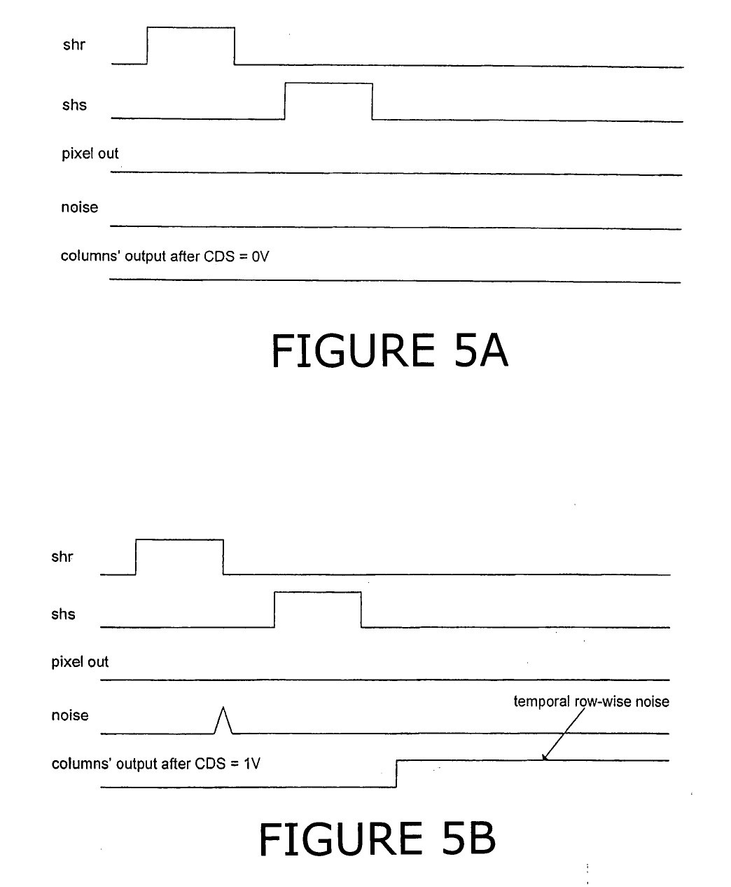

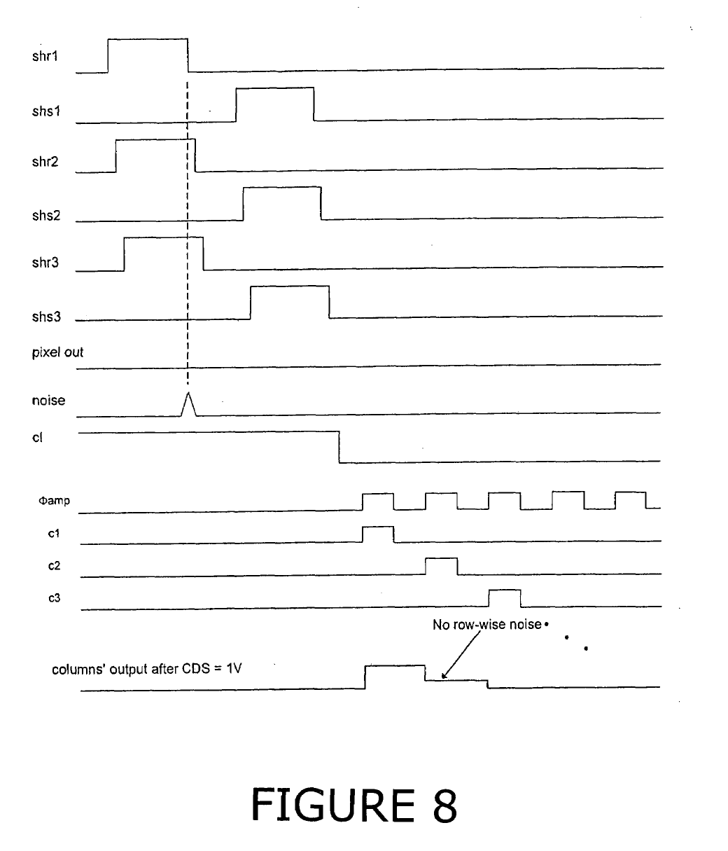

In the sample and hold circuit 261, the effect of noise that occurs during the sampling period defined by control signal c1 is mitigated because the signals vᵣₛₜ, v_{sig} for each column are not sampled simultaneously. For example, FIG. 8 illustrates a timing diagram for the sample and hold circuit 261 when noise has been detected during the sampling period. In the example of FIG. 8, a 1 V noise spike is detected at the time of the falling edge of the shr1 control signal. Had all columns been sampled for vrst at the same time (e.g., at the falling edge of the shr1 control signal), the effect of the detected noise would have been applied to all pixels in the sampled row (as demonstrated in FIG. 5B). However, in this case, the noise only affects a few pixel signals. The 1 V noise spike occurs during the falling edge of the reset sample and hold control signal shr1. Thus, the values for the sampled values for the pixel read in column C1 will be affected. At the time of the falling edge of the shr2 signal (when the pixel in column C2 is being sampled), the same noise signal has been reduced to about 0.5 V. At the time of the falling edge of the shr3 signal (when the pixel in column C3 is being sampled), the noise has disappeared entirely. Thus, the noise signal only results in an offset for the pixels readout from columns C1 and C2. The pixel values output from columns C3-Cn will not have an offset. In this way, acquired noise does not affect the entire pixel row, and thus the row-wise temporal noise evident in FIG. 1 will not be present. Instead, random and less recognizable pixel-related noise may be manifest.

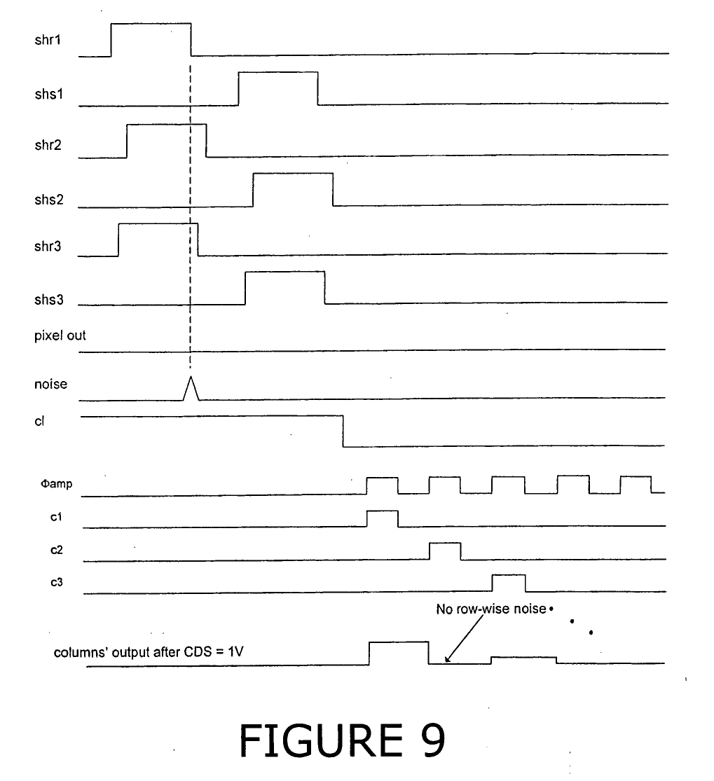

An additional timing diagram for the sample and hold circuit 261 is illustrated in FIG. 9. As FIG. 9 illustrates, the sampling of reset and image signals vᵣₛₜ, v_{sig} need not proceed in sequential column order, as illustrated in FIG. 8. In other words, it is not necessary that the reset signal vᵣₛₜ of column C3 be sampled after the reset signal vᵣₛₜ of column C2 is sampled. In fact, pixel-related noise may be increasingly randomized by sampling adjacent columns non-sequentially. In the timing diagram of FIG. 9, column C1 is first sampled, then column C3, followed by column C2. In this way, noise acquired during the sampling of column C1 is only evident from the pixel outputs of columns C1 and C3. Because the pixels from columns C1 and C3 are not adjacent to each other, the resulting noise and offset is even less apparent to one viewing the resulting image.

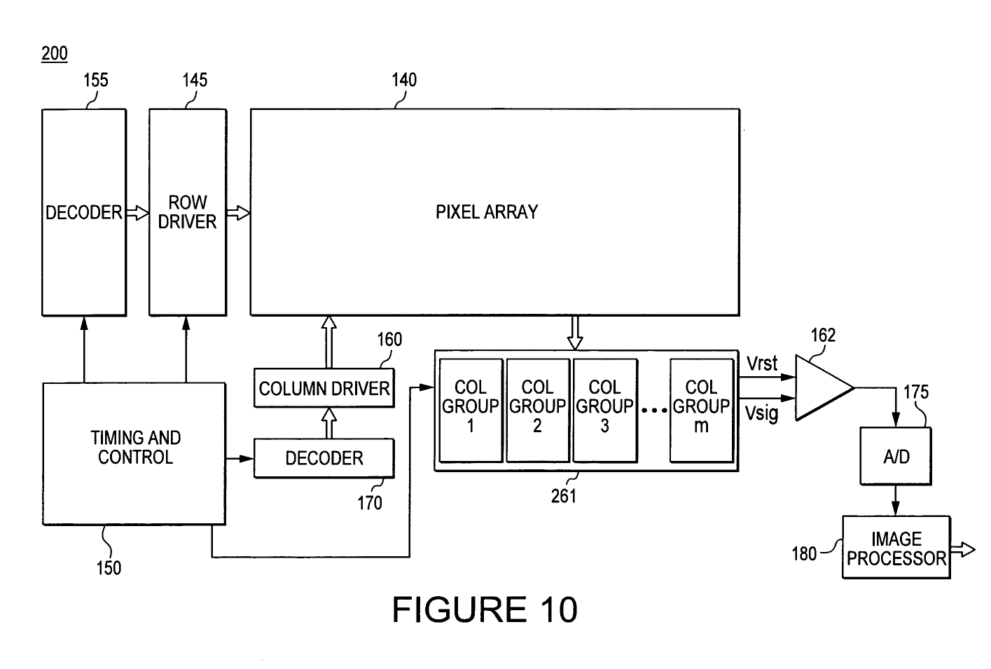

Because the typical imager has many hundreds or even thousands of columns, the complexities of providing a separate reset sample and hold control signal shr and image sample and hold control signal shs for each column may not be practical. Accordingly, the total number of columns may be organized into m groups of n columns each, as illustrated in the imager 200 of FIG. 10. In FIG. 10, the sample and hold circuit 261 is organized into groups 1-m. Each column in a group is sampled independently of the other columns in the same group. However, columns in one group may share common sample and hold control signals with columns in other groups. Thus, for m groups of n columns each, or m×n columns total, only n reset sample and hold control signals and n image sample and hold control signals need be used. The greater the value of n, the more random pixel-related noise will appear in the digitized image, but the more complex the timing and control unit 150 logic will be. Each of the m groups may include n adjacent columns or n non-adjacent columns spread across the pixel array. For example, a group may include eight columns including columns C1-C8. Alternatively, an eight-column group may include columns C1, C33, C65, C97, etc., spread across the entire pixel array.

One skilled in the art will also recognize that the improved sample and hold circuit 261 and method explained above is not limited to groupings of pixel columns. For example, other pixel array architectures may be used in which the sample and hold circuit described above is applied to the common pixel output lines of one or more pixels, groupings or arrangements, regardless of the pixel organization in columns, rows, radii, arcs, or other pixel arrangements.

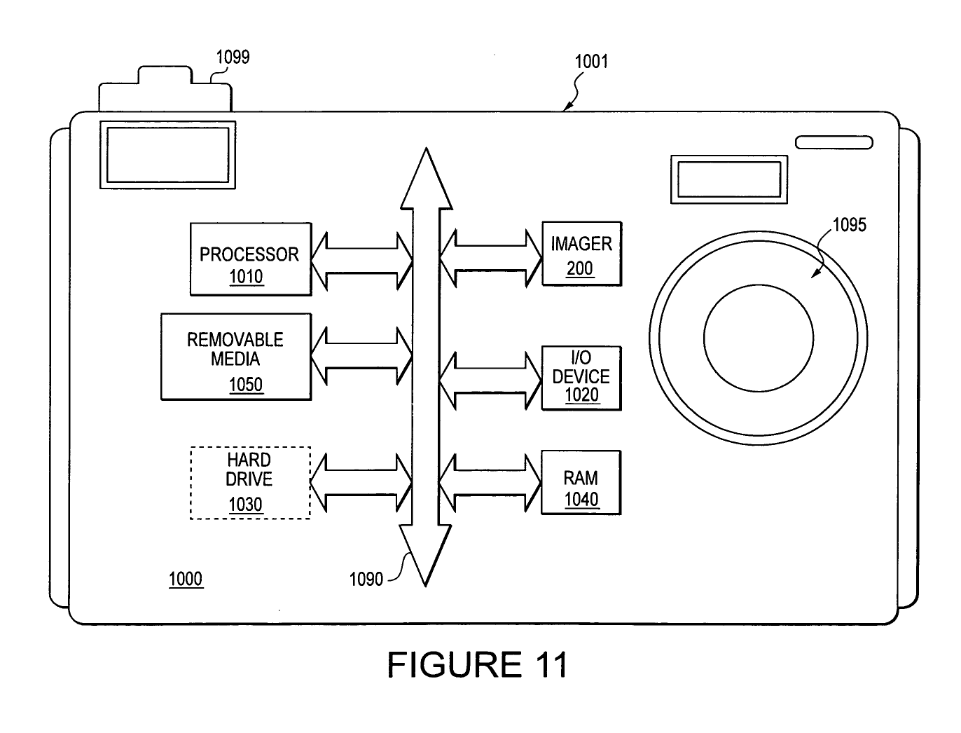

The sampling and hold circuit 261 explained above may be used in any system which employs an imager device, including, but not limited to a computer system, camera system, scanner, machine vision, vehicle navigation, video phone, surveillance system, auto focus system, star tracker system, motion detection system, image stabilization system, and other imaging systems. Example digital camera systems in which the invention may be used include both still and video digital cameras, cell-phone cameras, handheld personal digital assistant (PDA) cameras, and other types of cameras. FIG. 11 shows a typical processor system 1000 which is part of a digital camera 1001. The processor system 1000 includes an imaging device 200 which includes a sample and hold circuit constructed in accordance with the embodiments described above. System 1000 generally comprises a processing unit 1010, such as a microprocessor, that controls system functions and which communicates with an input/output (I/O) device 1020 over a bus 1090. Imaging device 200 also communicates with the processing unit 1010 over the bus 1090. The processor system 1000 also includes random access memory (RAM) 1040, and can include removable media 1050, such as flash memory, which also communicates with the processing unit 1010 over the bus 1090. Lens 1095 focuses an image on a pixel array of the imaging device 200 when shutter release button 1099 is pressed.

The processor system 1000 could alternatively be part of a larger processing system, such as a computer. Through the bus 1090, the processor system 1000 illustratively communicates with other computer components, including but not limited to, a hard drive 1030 and one or more removable media devices 1050. The imaging device 200 may be combined with a processor, such as a central processing unit, digital signal processor, or microprocessor, with or without memory storage on a single integrated circuit or on a different chip than the processor.

It should again be noted that although the embodiments of the invention have been described with specific reference to CMOS imaging devices, they have broader applicability and may be used in any imaging apparatus which generates pixel output values from a pixel array.

1. A pixel array, comprising:
a plurality of sample and hold circuits, each respectively coupled to a pixel set output line of said pixel array;
a plurality of first control lines for controlling a first sample and hold operation of said sample and hold circuits; and
a control circuit for providing sampling signals on said respective plurality of first control lines which are staggered in time.

2. The circuit of claim 1, wherein the signals provided on said plurality of first control lines are provided at different times to respective sample and hold circuits within a group of the plurality of sample and hold circuits.

3. The circuit of claim 1, wherein sample and hold circuits for adjacent pixel sets are coupled to different ones of the plurality of first control lines.

4. (canceled)

5. The circuit of claim 1, wherein each of the first control lines control a respective group of sample and hold circuits.

6. (canceled)

7. The circuit of claim 5, wherein sample and hold circuits in a same group sample and hold signals from non-adjacent pixel set output lines of said array.

8. The circuit of claim 1, further comprising an amplifier coupled to each of the plurality of sample and hold circuits for amplifying signals obtained during the first sample and hold operations.

9. A pixel array, comprising:
a plurality of sample and hold circuits, each respectively coupled to a pixel set output line of said pixel array;
a plurality of first control lines for controlling a first sample and hold operation of said sample and hold circuits;
a plurality of second control lines for controlling a second sample and hold operation of said sample and hold circuits; and
a control circuit for providing respective signals on said plurality of first and second control lines which are staggered in time.

10. The circuit of claim 9, wherein the signals provided on said plurality of first and second control lines are provided at different times to the sample and hold circuits within a group of the plurality of sample and hold circuits.

11. (canceled)

12. The circuit of claim 9, wherein the sample and hold circuits each include first and second sample and hold units, each respectively controlled by a first and second control line.

13-16. (canceled)

17. The circuit of claim 9, wherein each of the sample and hold circuits further comprises first and second sample and hold circuits for sampling and holding a pixel reset signal in response to respective first and second control signals.

18. (canceled)

19. The circuit of claim 9, further comprising an amplifier coupled to each of the plurality of sample and hold circuits for amplifying signals obtained during the first and second sample and hold operations, the amplifier having a first common input for all signals obtained during the first sample and hold operation and a second common input for all signals obtained during the second sample and hold operation.

20. (canceled)

21. An imaging system, comprising:
a pixel array;
a timing and control circuit for providing at least two independent first control signals which are offset in time from one another; and
at least two sample and hold circuits, each respectively coupled to a column line of a pixel array, and each configured to receive one of the independent first control signals as a sampling control signal.

22. The system of claim 21, further comprising a timing and control circuit for providing at least two independent second control signals which are offset in time from one another, wherein each of said sample and hold circuits is configured to receive one of the independent second control signals.

23. The system of claim 22, wherein the timing and control circuits provide the independent first and second control signals to sample and hold circuits within a group of the sample and hold circuits at different times.

24. The system of claim 22, wherein sample and hold circuits for adjacent pixel columns are configured to receive different ones of the independent first control signals and different ones of the independent second control signals.

25. (canceled)

26. The system of claim 22, wherein sample and hold circuits within a group of the plurality of sample and hold circuits are each configured to receive different independent first and second control signals.

27-30. (canceled)

31. A method of sampling pixel outputs from pixels in a pixel array, the method comprising:
sampling a pixel signal from a first pixel of a first row and a first column in the pixel array; and
sampling a pixel signal from a second pixel of the first row and a second column in the pixel array at a different time than when the first pixel is sampled.

32. The method of claim 31, further comprising sampling a first and a second pixel signal from each of the first and second pixels, the first and second pixel signals from the first pixel being sampled at a different time than the first and second pixel signals sampled from the second pixel.

33. The method of claim 31, further comprising organizing the pixel columns in the array into groups, the first and second pixel columns being in a first group, wherein pixel signals from each pixel of the first pixel row in pixel columns of the first group are sampled at different times.

34-35. (canceled)

36. The method of claim 33, wherein the sampling includes sampling pixel signals from adjacent pixel columns in a non-consecutive order.

37. (canceled)

38. A method of reducing noise during sampling of a pixel array, the method comprising:
sampling pixel signals from pixels in the pixel array using a plurality of sample and hold circuits; and
controlling said sampling using a plurality of first control signals offset in time from each other, each sample and hold circuit receiving one of said first control signals.

39. The method of claim 38, further comprising controlling said sampling using a plurality of second control signals offset in time from each other, each sample and hold circuit receiving one of said second control signals.

40-41. (canceled)

42. The method of claim 39, further comprising determining a difference between the sampled reset signal and the sampled image signal for each pixel, wherein the first control signals are used to control the sampling of a reset signal from each pixel, and the second control signals are used to control the sampling of an image signal from each pixel.

43. (canceled)

44. The method of claim 39, wherein sample and hold circuits are grouped and each sample and hold circuit in a group receives different first and second control signals.

45. (canceled)

46. The method of claim 44, wherein groups include sample and hold circuits for non-adjacent pixel columns.
